(19) United States
(12) Patent Application Publication
(10) Pub. No.: US 2026/0320748 A1
(43) Pub. Date: Oct. 15, 2026

(54) IMAGE CONVERSION DEVICE, IMAGE CONVERSION METHOD, AND IMAGE CONVERSION SYSTEM

(71) Applicant: Evident Corporation, Tatsuno-machi (JP)

(72) Inventors: Yuki TOKUHASHI, Kamiina-gun (JP); Yoshimasa SUZUKI, Kamiina-gun (JP); Satoshi WATANABE, Kamiina-gun (JP); Yuya MIYAZONO, Kamiina-gun (JP)

(73) Assignee: Evident Corporation, Tatsuno-machi (JP)

(21) Appl. No.: 19/467,874

(22) Filed: Feb. 3, 2026

(30) Foreign Application Priority Data
Feb. 10, 2025 (JP) 2025-019692

(51) Int. Cl. G06T 5/50; G06T 5/60; G06T 7/00

(52) U.S. Cl. CPC G06T 5/50; G06T 5/60; G06T 7/0002; G06T 2200/04; G06T 2207/10056; G06T 2207/10064; G06T 2207/20021; G06T 2207/20081; G06T 2207/20084; G06T 2207/20212; G06T 2207/30024

(57) ABSTRACT

An image conversion device converts a third three-dimensional fluorescence image of a measurement specimen by first excitation light into a fourth three-dimensional fluorescence image by using a trained model in which a plurality of pair images, each including a first three-dimensional fluorescence image of a learning specimen by the first excitation light and a second three-dimensional fluorescence image of the learning specimen by second excitation light having a longer wavelength than the first excitation light, is learned as a supervision image.

### CROSS REFERENCE TO RELATED APPLICATIONS

This application is based upon and claims the benefit of priority of the prior Japanese Patent Application No. 2025-019692, filed Feb. 10, 2025, the entire contents of which are incorporated herein by reference.

### BACKGROUND

### Technical Field

The present invention relates to an image conversion device using a trained model, an image conversion method using a trained model, and an image conversion system using a trained model.

### Related Art

Fluorescence microscopes can fluorochrome-label and observe an intracellular organelle, a protein, and the like, and thus play an important role in determining a cell function. In particular, since confocal microscopes block light other than that at the focal position by a pinhole arranged at the conjugate position with a specimen, a high-resolution three-dimensional fluorescence image can be acquired.

With the recent progress of culture technology, it has become possible to produce cell aggregates such as spheroids and organoids in which a large number of cells are collected and cultured in three dimensions. It is known that cell aggregates exhibit a function or behavior closer to the inside of a living body than a two-dimensional cell. Therefore, cell aggregates are widely used in drug efficacy evaluation, regenerative medicine, and the like.

### SUMMARY

An image conversion device of an embodiment is an image conversion device including a processor, wherein the processor converts a third three-dimensional fluorescence image of a measurement specimen by first excitation light into a fourth three-dimensional fluorescence image by using a trained model in which a plurality of pair images, each including a first three-dimensional fluorescence image of a learning specimen by the first excitation light and a second three-dimensional fluorescence image of the learning specimen by second excitation light having a longer wavelength than the first excitation light, is learned as a supervision image.

An image conversion method of an embodiment includes: converting a third three-dimensional fluorescence image of a measurement specimen by first excitation light into a fourth three-dimensional fluorescence image by using a trained model in which a plurality of pair images, each including a first three-dimensional fluorescence image of a learning specimen by the first excitation light and a second three-dimensional fluorescence image of the learning specimen by second excitation light having a longer wavelength than the first excitation light, is learned as a supervision image.

An image conversion system of an embodiment includes the image conversion device of the embodiment and a microscope, in which at least the third three-dimensional fluorescence image is an image acquired by the microscope.

### BRIEF DESCRIPTION OF THE DRAWINGS

FIG. 1 is a configuration diagram of an image conversion system including an image conversion device of a first embodiment;

FIG. 2 is a diagram describing a method of creating a trained model of the image conversion device of the first embodiment;

FIG. 3 is a diagram describing a method of operating the image conversion device of the first embodiment;

FIG. 4 is a diagram describing an effect of the image conversion device of the first embodiment;

FIG. 5 is a configuration diagram of an image conversion system including an image conversion device of a second embodiment;

FIG. 6 is a plan view describing image division in an image conversion device of a first modification of the second embodiment;

FIG. 7 is a diagram describing weighting on a divided image in an image conversion device of a second modification of the second embodiment;

FIG. 8 is a diagram describing a method of creating a trained model of an image conversion device of a third embodiment;

FIG. 9 is a diagram describing image type classification of the image conversion device of the third embodiment;

FIG. 10 is a diagram describing a method of operating the image conversion device of the third embodiment;

FIG. 11 is a diagram describing a method of creating a trained model of an image conversion device of a first modification of the third embodiment;

FIG. 12 is a diagram describing a method of operating the image conversion device of the first modification of the third embodiment;

FIG. 13 is a diagram describing a method of operating an image conversion device of a second modification of the third embodiment;

FIG. 14 is a diagram describing weighting of the image conversion device of the second modification of the third embodiment;

FIG. 15 is an example of a three-dimensional fluorescence image, in which the right diagram is a cross section taken along line A-A in the left diagram;

FIG. 16 is an example in which an image is classified into four types with the number of features of 2, in which the right diagram is a cross section taken along line A-A in the left diagram; and

FIG. 17 is an example in which an image is classified into six types with the number of features of 10, in which the right diagram is a cross section taken along line A-A in the left diagram.

### DESCRIPTION OF THE EMBODIMENTS

In the case of fluorescent observation of a deep portion of a three-dimensional cell aggregate, light scattering occurs in an organelle or a granule including a cell nucleus, and a point image is easily disturbed.

In order to reduce the effect of light scattering, a transparency technique, wavefront compensation correction, deconvolution, and a multiphoton-excited scanning laser microscope device are used.

In the transparency technique, scattering is reduced by making the refractive index different between cells uniform using a transparency reagent. However, the specimen shape may change due to the dehydration action of the transparency reagent.

In the wavefront compensation correction, the disturbance of the point image due to scattering is corrected at the time of image acquisition, and in the deconvolution, the disturbance is corrected after the image acquisition. However, it is not easy to accurately estimate the disturbance of the point image (particularly, of the deep portion) based on the measurement and design information before the image acquisition, and a wavefront compensation correction device is complicated. On the other hand, deconvolution requires time for processing.

JP 2003-15045 A discloses a multiphoton-excited scanning laser microscope device that detects fluorescence due to multiphoton absorption of a specimen. For example, in a two-photon excitation microscope, fluorescence excitation performed at a wavelength of 400 nm (single photon) is performed at 800 nm, which is twice the wavelength. The two-photon excitation microscope can suppress light scattering more than a one-photon excitation microscope. However, two-photon excitation microscopes are complex in structure and expensive.

WO 2023/276327 A discloses image processing for reducing noise of an image by using a trained model selected from among a plurality of trained models based on an image acquisition condition.

Hereinafter, embodiments of the present invention will be described with reference to the drawings. The drawings based on the embodiments are schematic. Illustration and reference numerals of some components are omitted.

### First Embodiment

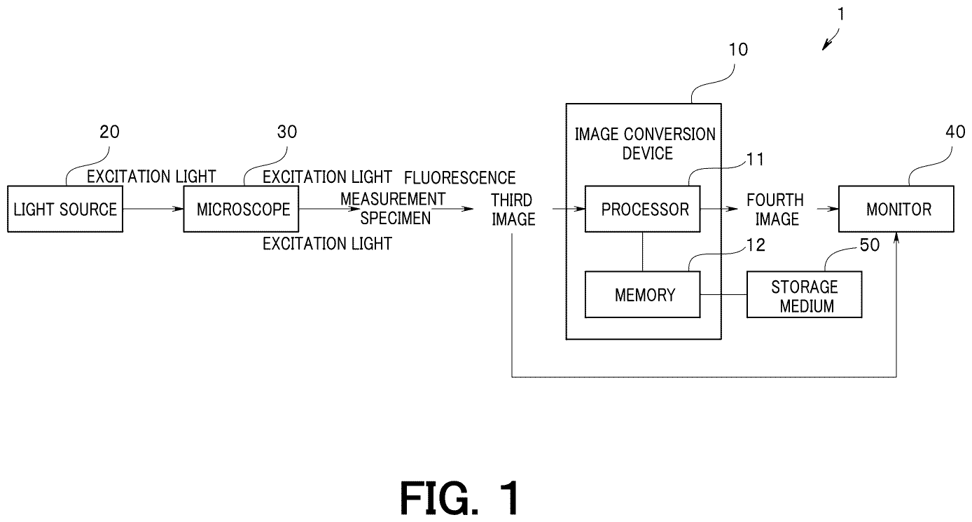

As illustrated in FIG. 1, an image conversion device 10 of the present embodiment constitutes an image conversion system 1 together with a light source 20, a microscope 30, and a monitor 40.

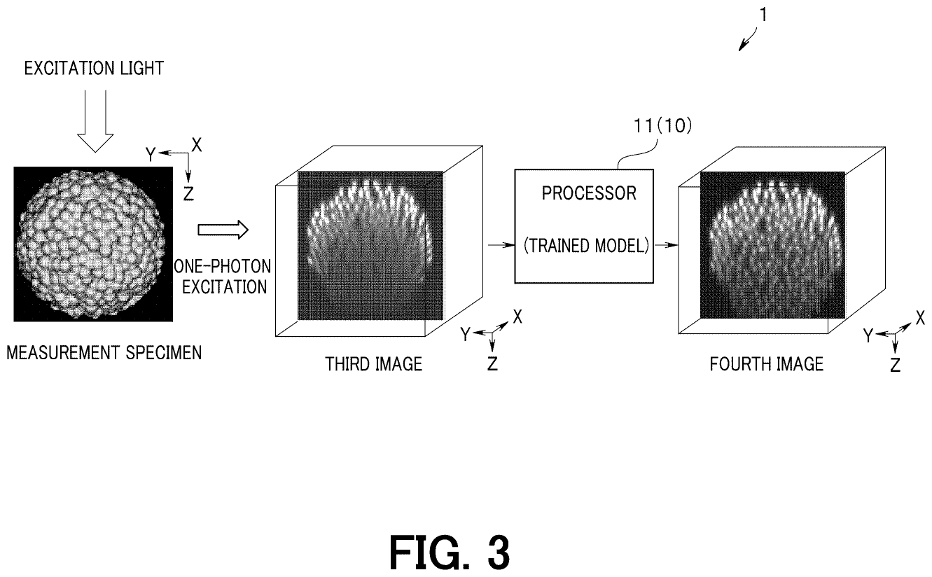

The light source 20 generates excitation light. The microscope 30 irradiates a measurement specimen with the excitation light from the light source 20, and receives the fluorescence generated by the measurement specimen. The microscope 30 is a confocal laser microscope that captures a third image (see FIG. 3), which is a three-dimensional fluorescence image. The light source 20 and the microscope 30 may be integrated.

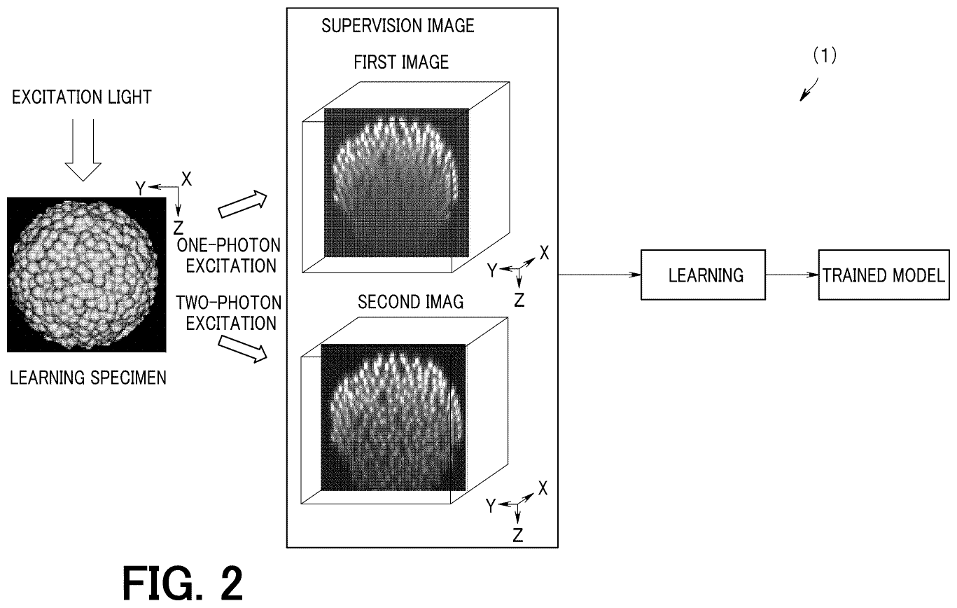

The image conversion device 10 includes a processor 11 and a memory 12. The processor 11 reads the trained model (see FIG. 2) stored in the memory 12, performs artificial intelligence (AI) conversion processing on the third image, and outputs a fourth image (see FIG. 3). Note that, in the present specification, for example, image conversion processing using an inference model generated by machine learning is referred to as “AI conversion”. For example, 3D-UNet or volumetric UNet (vnet) obtained by extending a learning network structure (UNet) of a U-shaped encoder/decoder is used for learning/conversion of an image that is three-dimensional volume data.

The processor 11 may be configured by an internal circuit of a semiconductor element processed by software or a dedicated hardware circuit. For example, the processor 11 may include a field programmable gate array (FPGA) including a hardware circuit and a graphics processing unit (GPU) that is a software circuit. The memory 12 including RAM or the like may acquire a trained model and an operation program (software) via a storage medium 50 or a network line.

The monitor 40 is a liquid crystal display or the like that displays an image or the like output from the microscope 30 or the image conversion device 10.

A method of generating the trained model will be described with reference to FIG. 2. Note that a learning specimen illustrated in FIG. 2 is a side view, and a supervision specimen is a cross-sectional view. The downward direction of the drawing (positive direction of the Z axis) indicates the depth direction of the specimen.

A microscope (not illustrated) for acquiring a supervision image is a microscope capable of both two-photon excitation observation and one-photon excitation observation (confocal observation). For example, for one learning specimen, a first three-dimensional fluorescence image (first image) by first excitation light of a first wavelength by a one-photon excitation method and a second three-dimensional fluorescence image (second image) by second excitation light of a second wavelength by a two-photon excitation method are photographed. That is, the supervision image includes a plurality of pair images (first image and second image) of a plurality of learning specimens. Note that the first image and the second image may be acquired by using a microscope for performing one-photon excitation observation and a microscope for performing two-photon excitation observation as different microscopes. The first image and the second image of the supervision image may be created not by measurement but by simulation.

Since the second wavelength (800 nm) by the two-photon excitation method is longer than the first wavelength (400 nm) by the one-photon excitation method, there is less light scattering.

The trained model (hereinafter, referred to as the “model”) is obtained by machine learning using a plurality of pair images each having a first image and a second image as supervision images. The model is stored in the memory 12.

The model is a deep neural network (DNN) that has a plurality of hidden layers and performs deep learning. The model may be a convolution neural network (CNN), regions with CNN features using CNN (R-CNN), fully convolutional networks (FCN), or the like.

As illustrated in FIG. 2, since the second image has a smaller effect of scattering than the first image, disturbance of the point image is small, and in particular, details are clear even in a deep portion of the specimen.

Note that the intensity of the excitation light with which the specimen is irradiated is preferably higher when the deep portion of the specimen is photographed than when the surface of the specimen is photographed.

Next, a method for operating the image conversion system 1 will be described with reference to FIG. 3.

As described above, the microscope 30 is a confocal laser microscope that outputs a third three-dimensional fluorescence image (third image) of the measurement specimen at the first excitation wavelength (400 nm). The first image, the second image, and the third image are scanning microscope images. However, the microscope 30 is an inexpensive microscope capable of acquiring only a confocal image by one-photon excitation, as compared with the two-photon excitation microscope capable of acquiring a two-photon excitation image or a microscope capable of acquiring both a two-photon excitation image and a one-photon excitation image (confocal image), which acquires a supervision image. In the third image, for example, an XY two-dimensional image is 768 pixels×768 pixels, and has 320 pixels in a Z direction. In other words, the third image is an image in which 320 two-dimensional images are stacked in the Z direction.

The third image is input to the model of the processor 11 and subjected to AI conversion into a fourth three-dimensional fluorescence image (fourth image). In the fourth image, the disturbance of the point image is suppressed as compared with the third image.

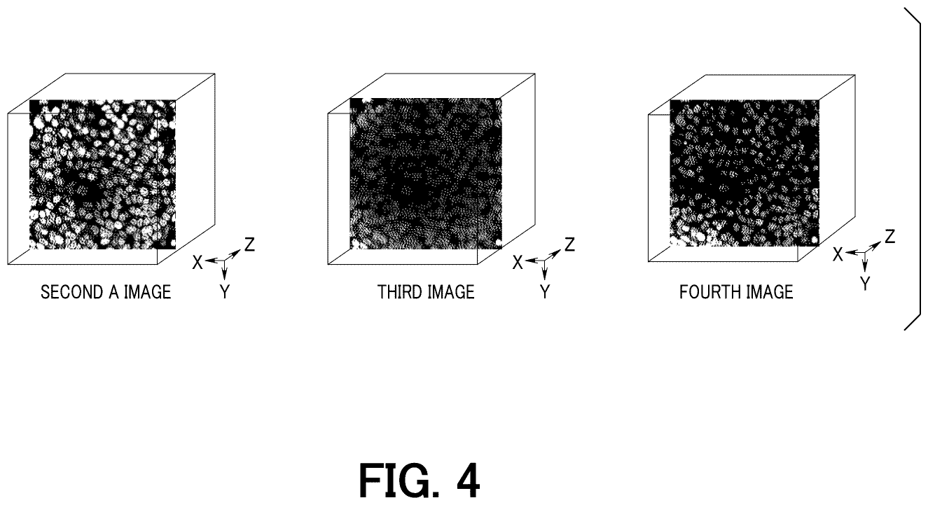

Therefore, in a second A image (see FIG. 4) obtained by photographing the measurement specimen with the two-photon excitation microscope, a second correlation coefficient with the fourth image is higher than a first correlation coefficient with the third image. As the correlation coefficient, a known method such as a Pearson product-moment correlation coefficient, a SAD method for calculating a sum of absolute values of differences in luminance values, an SSD method for calculating a sum of squares of differences in luminance values, or a normalized cross-correlation method can be used.

For example, in an XY partial image (200 μm×200 μm, Z-direction depth of 150 μm) illustrated in FIG. 4, a first Pearson product-moment correlation coefficient of the second A image and the third image was 0.66, and a second Pearson product-moment correlation coefficient of the second A image and the fourth image was 0.76.

Note that, in the image conversion system 1, the first image was photographed with the one-photon excitation microscope, and the second image was photographed with the two-photon excitation microscope. However, two types of learning specimens may be prepared using fluorochromes or fluorescent proteins that generate fluorescence of different wavelengths, and both the first image and the second image may be photographed with the one-photon excitation microscope.

In addition, in the image conversion system 1, the second wavelength (800 nm) is 200% of the first wavelength (400 nm), but, insofar as the second wavelength is more than 125% of the first wavelength, the effect of the invention is remarkable.

As described above, the image conversion method converts the third three-dimensional fluorescence image of the measurement specimen by the first excitation light into the fourth three-dimensional fluorescence image by using the trained model in which the plurality of pair images, each including the first three-dimensional fluorescence image of the learning specimen by the first excitation light and the second three-dimensional fluorescence image of the learning specimen by the second excitation light having a longer wavelength than the first excitation light, is learned as the supervision image.

An image conversion program causes a computer to execute processing of converting the third three-dimensional fluorescence image of the measurement specimen by the first excitation light into the fourth three-dimensional fluorescence image by using the trained model in which the plurality of pair images, each including the first three-dimensional fluorescence image of the learning specimen by the first excitation light and the second three-dimensional fluorescence image of the learning specimen by the second excitation light having a longer wavelength than the first excitation light, is learned as the supervision image.

The non-transitory computer-readable storage medium 50 stores the above program.

Note that the luminance of the measured fluorescence image is preferably scaled to 0 to 1 and then divided into area images. By scaling, data measured at different intensity levels can be similarly processed.

### Second Embodiment

An image conversion device 10A of the present embodiment described below is similar to the image conversion device 10. Therefore, components having the same functions as those of the image conversion device 10 are denoted by the same reference numerals, and description thereof is omitted.

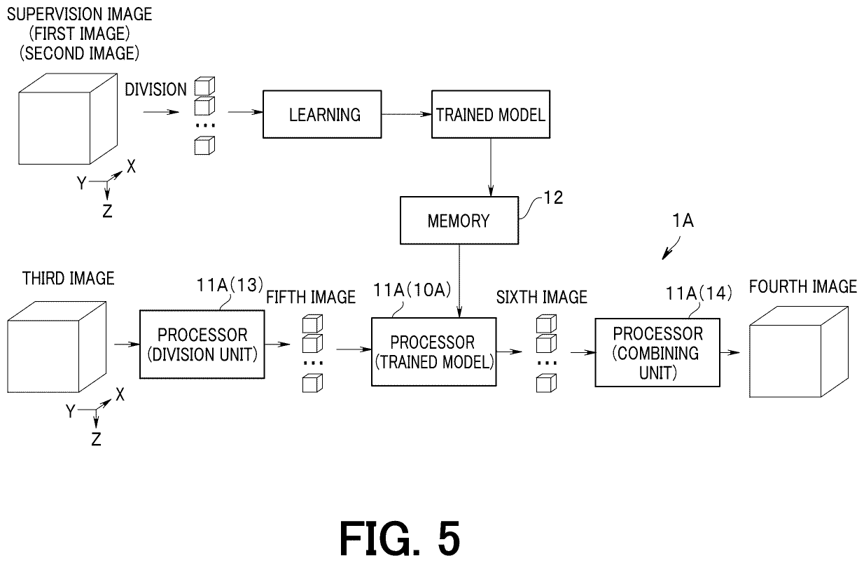

As illustrated in FIG. 5, in an image conversion system 1A, the supervision image (the first image and the second image) is divided into a plurality of images at the time of model creation, and machine learning is performed using the plurality of divided supervision images to create one model.

A processor 11A includes a division unit 13 that divides the third image into a plurality of fifth three-dimensional fluorescence images (fifth images). The processor 11A inputs each of the plurality of fifth images to the model to perform AI conversion into a plurality of sixth three-dimensional fluorescence images (sixth images). The processor 11A includes a combining unit 14 that combines the plurality of sixth images to generate the fourth image.

The image conversion device 10A that processes the divided small images has a small processing load and can efficiently perform the AI processing.

For example, the three-dimensional image is divided into 441 pieces (divided into seven in X-axis direction, divided into seven in Y-axis direction, and divided into nine in Z-axis direction). Note that the dividing method can be set as appropriate, and the image may be divided into a plurality of images having different sizes. For example, the image may be divided into a plurality of images along the Z axis.

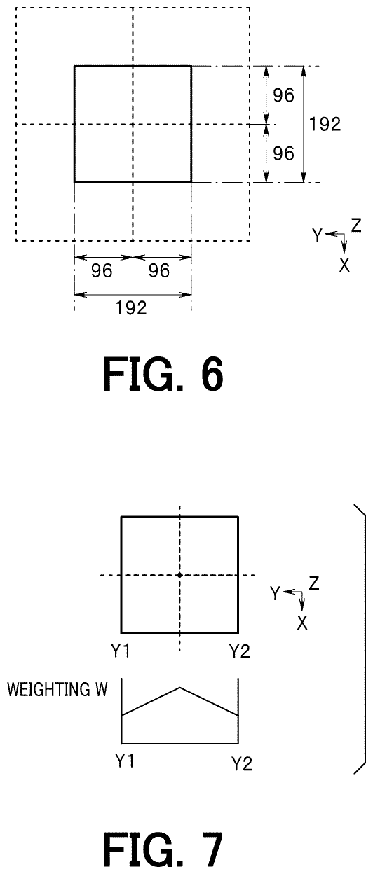

In addition, the image is preferably divided so as to overlap with an adjacent region. For example, the divided image (X-axis: 192 pixels, Y-axis: 192 pixels, Z-axis: 64 pixels) illustrated in FIG. 6 has an overlap region (X-axis: 96 pixels, Y-axis: 96 pixels, Z-axis: 32 pixels) with respect to a plurality of surrounding divided images. That is, in this example, the same number of pixels as the total number of pixels of the divided image overlaps the plurality of surrounding divided images.

By dividing and processing the image so as to overlap each other and then combining the images, the boundary regions of the plurality of divided images are brought into a natural state. Note that the overlap region is preferably 25% or more, particularly preferably 50% or more, of the total number of pixels of each divided image.

Further, the combining unit 14 of the processor 11A preferably weights the plurality of pixels of the sixth image according to the spatial positions of the respective pixels to combine the images into the fourth image. The weighting factor W (hereinafter, referred to as the “weight”) in weighting the pixels of the sixth image is set such that the pixel at the center position is larger than the pixels at the peripheral positions. In particular, it is preferable to perform weighting such that the effect from the region adjacent to the pixel at the boundary position is ½ (half).

FIG. 7 illustrates a weight W in the Y-axis direction of one divided image. In the X-axis direction and the Z-axis direction, the weight W is set as in the Y-axis direction. The weight W is set so as to be linearly decreased from the pixel at the center position toward the pixel at the peripheral position. The change pattern of the weight W is not limited to linear, and may be, for example, curved.

When the plurality of divided images having the weighted pixels are combined, the boundary region is brought into a more natural state.

### Third Embodiment

An image conversion device 10B of the present embodiment described below is similar to the image conversion device 10. Therefore, components having the same functions as those of the image conversion device 10 are denoted by the same reference numerals, and description thereof is omitted.

In the image conversion device 10B of the present embodiment, a processor 11B outputs the fourth image using a model according to a feature amount (number of features and value of features) from among a plurality of types of models according to the feature amount of the third image. That is, the plurality of types of models are classified based on the feature amounts.

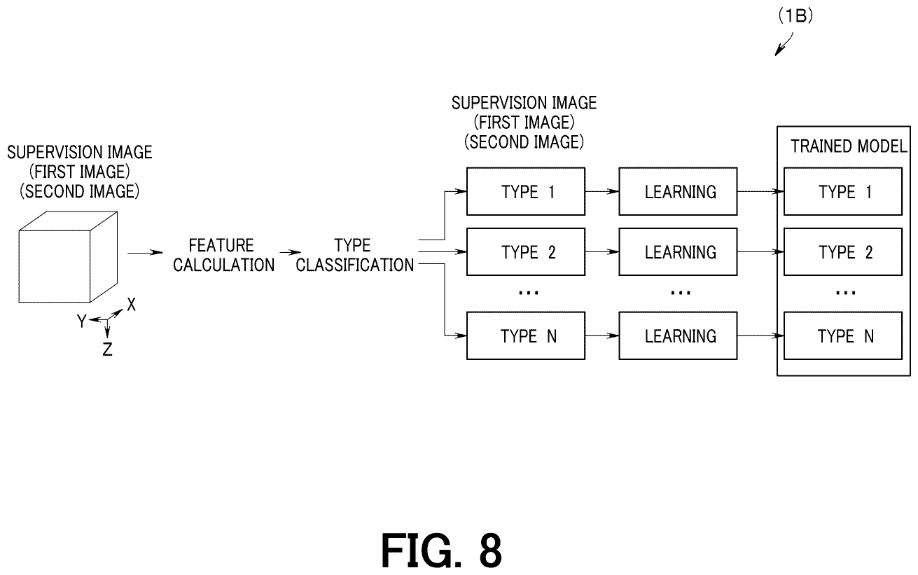

As illustrated in FIG. 8, the feature amount of the supervision image (first image) is calculated in order to create a plurality of types of models, and the supervision image is classified into Types 1 to N (N≥2) based on the feature amount. Then, learning processing is performed for each type, and N models are created.

The feature amount is at least one of a maximum value of luminance of a plurality of pixels constituting the image, a standard deviation of luminance of the plurality of pixels, a median of luminance of the plurality of pixels, entropy of the image, a minimum value of luminance of the plurality of pixels, an average value of luminance of the plurality of pixels, a ratio of luminance exceeding a predetermined value to all pixels, a ratio of luminance less than a predetermined value to all pixels, an S/N ratio estimated from autocorrelation of an image, and a value obtained by averaging local entropy in an area.

The median is a 0.5 k-th value when k pieces of luminance are arranged in order of magnitude. The entropy is a measure of texture disorder, and is calculated, for example, by setting the luminance of a plurality of pixels as a 256-grade histogram p, multiplying an i-th value pi of the histogram p by (log2pi), and then summing up.

On the other hand, known feature amounts such as a ratio of luminance exceeding a predetermined value to all pixels, a ratio of luminance less than a predetermined value to all pixels, an S/N ratio estimated from autocorrelation of an image, and local entropy obtained by averaging local entropy in an area may be used. The number of feature amounts may be one, but is preferably two or more.

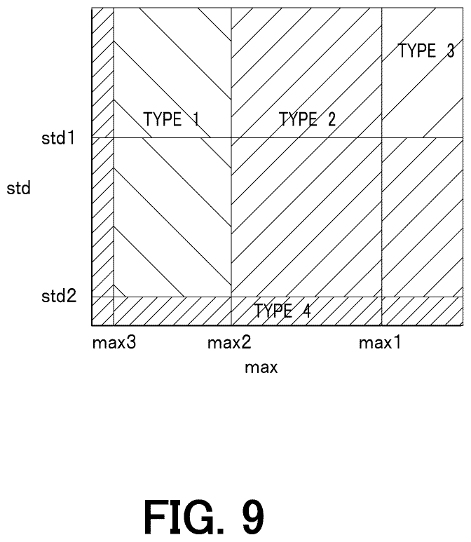

FIG. 9 and Table 1 illustrate an example in which a maximum value (max) and a standard deviation (std) are calculated as feature amounts and images are classified into a plurality of Types 1 to 4.

TABLE 1

| | |
|---|---|
| Type 1 | (max3 ≤ max < max2) and (std ≥ std2) |
| Type 2 | not (type 3) and (max ≥ max2) and (std ≥ std2) |
| Type 3 | (max > max1) and (std > std1) |
| Type 4 | (max < max3) or (std < std2) |

Note that Type 4 has a very poor S/N ratio, and thus learning is difficult and appropriate model creation is not easy. Therefore, in a case where the third image is classified into Type 4, the image conversion device 10B may perform the AI conversion processing using a model of Type 1.

In the above example, classification into four types is performed using two types of features, but for example, classification into six types may be performed using two types of features, or classification into nine types may be performed using three types of features.

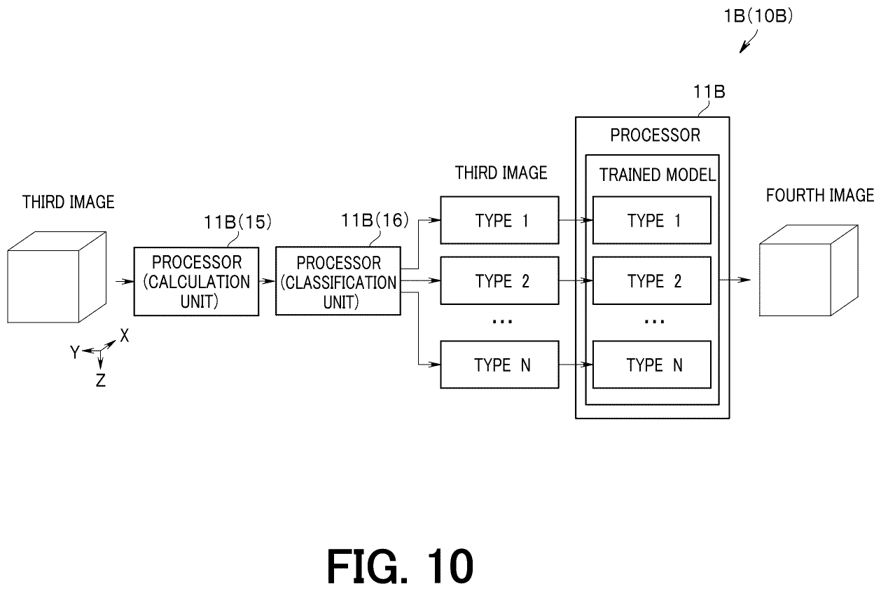

Then, as illustrated in FIG. 10, in an image conversion system 1B, in the third image obtained by photographing the measurement specimen, the same feature amount as that calculated in the supervision image is calculated by a calculation unit 15 of the processor 11B. Then, a classification unit 16 of the processor 11B classifies the third image into Types 1 to N based on the feature amount, similarly to the supervision image.

The image conversion device 10B using models of different types can output a favorable image.

### Modifications

Image conversion devices 10C to 10E of modifications described below are similar to the image conversion devices 10 to 10B. Therefore, components having the same functions as those of the image conversion devices 10 to 10B are denoted by the same reference numerals, and description thereof is omitted.

### First Modification

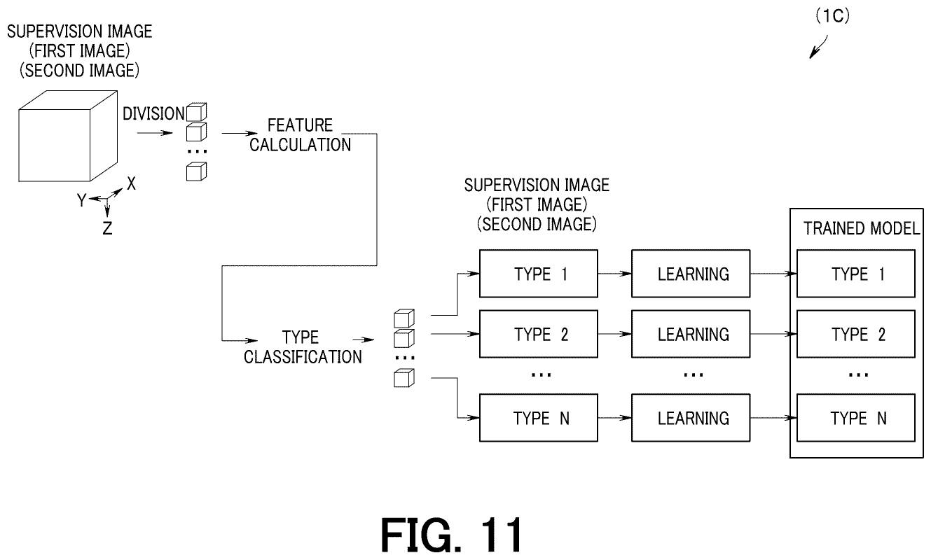

As illustrated in FIG. 11, in an image conversion system 1C of the present modification, the supervision image (the first image and the second image) is divided into a plurality of divided supervision images, and the feature amount of each of the plurality of divided supervision images is calculated. Based on the feature amount, the divided supervision images are classified into Types 1 to N (N≥2). Then, the learning processing is performed for each type, and N models are created.

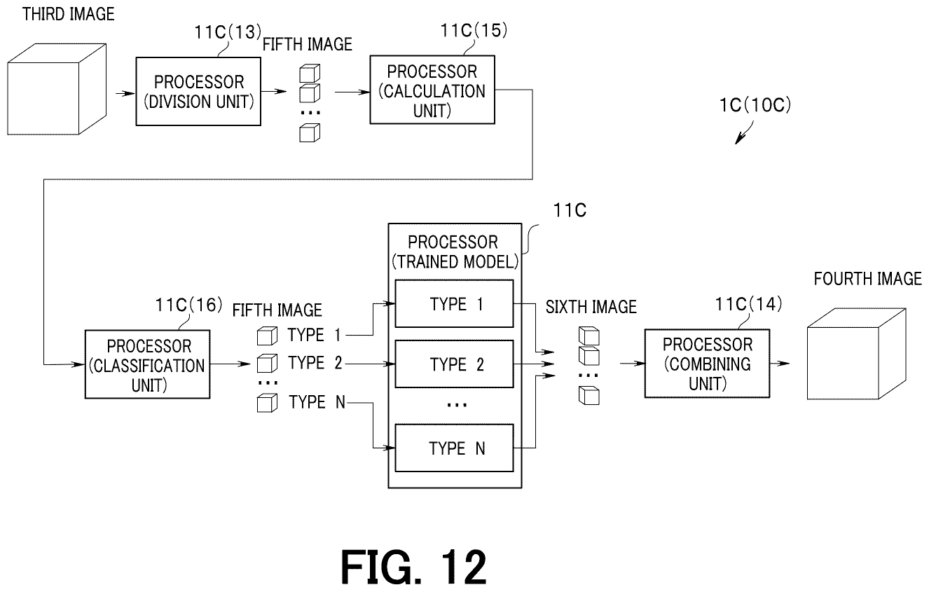

Then, as illustrated in FIG. 12, the third image obtained by photographing the measurement specimen is divided into a plurality of fifth three-dimensional fluorescence images (fifth images) by the division unit 13 of a processor 11C. The calculation unit 15 of the processor 11C calculates the feature amounts of the plurality of fifth images. Then, the classification unit 16 of the processor 11C classifies the plurality of fifth images into Types 1 to N based on the feature amounts.

The processor 11C inputs each of the plurality of fifth images to the trained model of each type, and performs the AI conversion processing into a plurality of sixth images. The combining unit 14 of the processor 11C combines the plurality of sixth images to generate the fourth image.

An image conversion device 10C using the model for each type for the divided image can output a favorable image. Further, the image conversion device 10C that processes the divided small image has a small processing load, and can efficiently perform the AI processing.

Note that, also in the image conversion device 10C, when the image is divided, the image may be divided so that the images overlap each other, or the weight may be changed according to the spatial position of the image.

### Second Modification

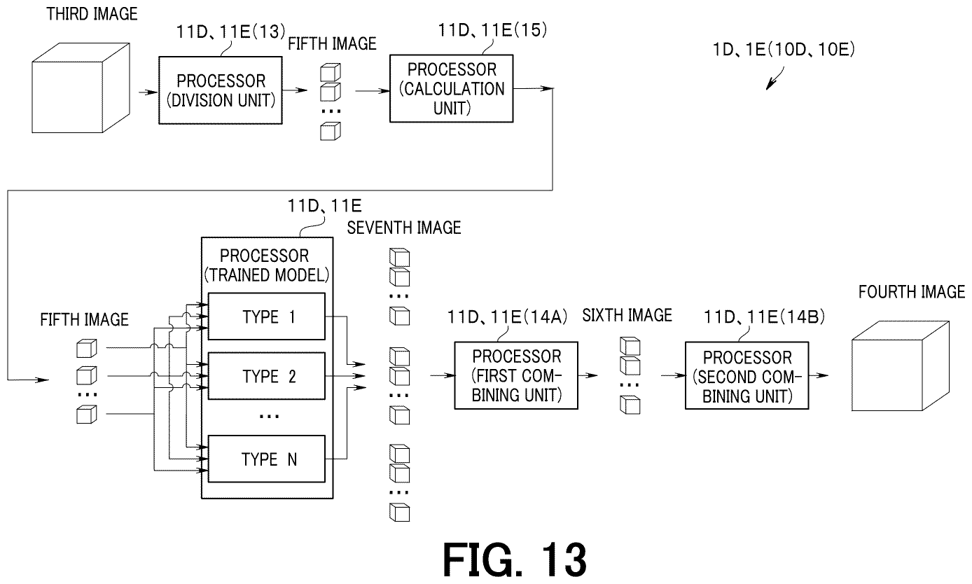

As illustrated in FIG. 13, a processor 11D of an image conversion device 10D of the present modification performs conversion processing of the divided fifth images into seventh images using a trained model for each type. When generating sixth images by combining the plurality of seventh images, a first combining unit 14A performs weighting based on the feature amounts of the fifth images. A second combining unit 14B combines the plurality of sixth images to generate the fourth image.

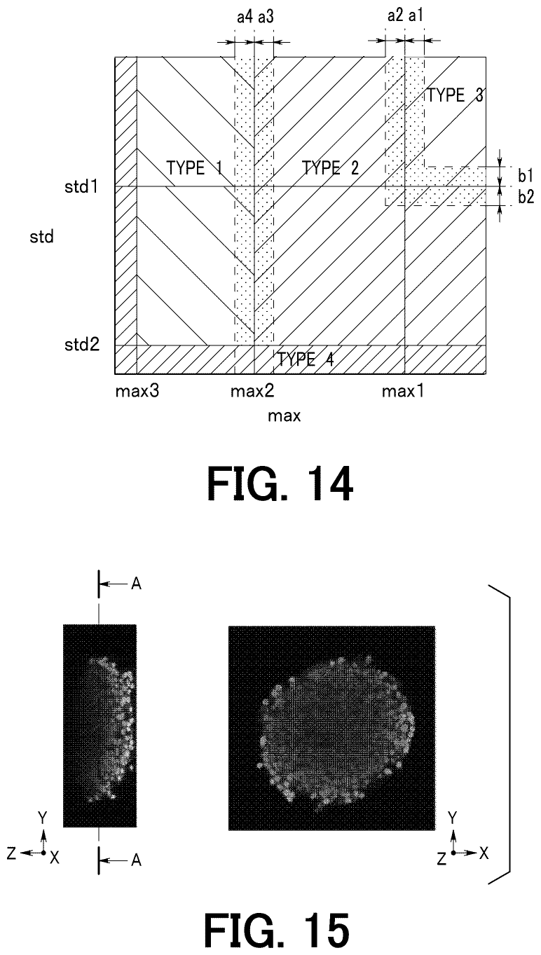

For example, at the time of model generation, as indicated in Table 2, type classification of divided supervision images is performed to create a plurality of models. Also at the time of image conversion of the fifth image, the model type is selected using the feature amounts (max and std), and for example, the weight of each model is set as indicated in Table 2. That is, as illustrated in FIG. 14, the boundary of the determination reference is set as the intermediate band, and in the intermediate band, the results from the two models are combined with a weight 0.5.

TABLE 2

| Determination condition | | Weight [type3, type2, type1] |
|---|---|---|
| case 1 | (max > max1 + a1) and (std > std1 + b1) | [1, 0, 0] |
| case 2 | not (case1) and (max ≥ max1 − a2) and (std ≥ std1 − b2) | [0.5, 0.5, 0] |
| case 3 | not (case1 or case2) and (max ≥ max2 + a3) and (std ≥ std2) | [0, 1, 0] |
| case 4 | (max2 − a4 ≤ max ≤ max2 + a3) and (std ≥ std2) | [0, 0.5, 0.5] |
| case 5 | (max3 ≤ max < max2 − a4) and (std ≥ std2) | [0, 0, 1] |
| case 6 | (max < max3) or (std < std2) | [0, 0, 1] |

Note that, in Table 2, the weight of the intermediate band (case2, case4) is a fixed value, but for example, the weight may be changed in an inclined manner according to the closeness to determination reference values (max1, max2).

### Third Modification

A processor 11E of an image conversion device 10E of the present modification performs a principal component analysis on the feature amount when performing type classification of the image, and selects a model on the basis of the result.

For example, in the image conversion device 10E, not only the maximum value (max) and the standard deviation (std) of the image but also more feature amounts are calculated, and the type is determined using them. A plurality of feature amounts of a large number of images is calculated in advance, and principal component analysis is performed to convert the feature amounts into coordinates of a principal component space. The image is classified into about 4 to 6 types using a clustering method such as a k-means method with respect to the coordinates of the principal component space, and barycentric coordinates γ (Table 3) in the principal component space of the image of each type are calculated. A coefficient β (Table 4) for converting a feature amount FT into a principal component PC is set in advance by the above-described principal component analysis.

TABLE 3

Principal component

| Type | PC1 | PC2 | PC3 | PC4 |
|---|---|---|---|---|
| Type 1 | γ11 | γ12 | γ13 | γ14 |
| Type 2 | γ21 | γ22 | γ23 | γ24 |
| Type 3 | γ31 | γ32 | γ33 | γ34 |
| Type 4 | γ41 | γ42 | γ43 | γ44 |

TABLE 4

Principal component

| Feature | PC1 | PC2 | PC3 | PC4 |
|---|---|---|---|---|
| FT1 | β11 | β12 | β13 | β14 |
| FT2 | β21 | β22 | β23 | β24 |
| . . . | | | | |
| FTn | βn1 | βn2 | βn3 | βn4 |

The feature amounts of the image to be subjected to the type determination are converted into coordinates in the principal component space using Table 4, and a distance D with respect to the barycentric coordinates of each type is determined (Table 5). The type of the barycenter at which the distance D is minimum is the type of this image.

TABLE 5

| Type 1 | Type 2 | Type 3 | Type 4 |
|---|---|---|---|
| Di1 | Di2 | Di3 | Di4 |

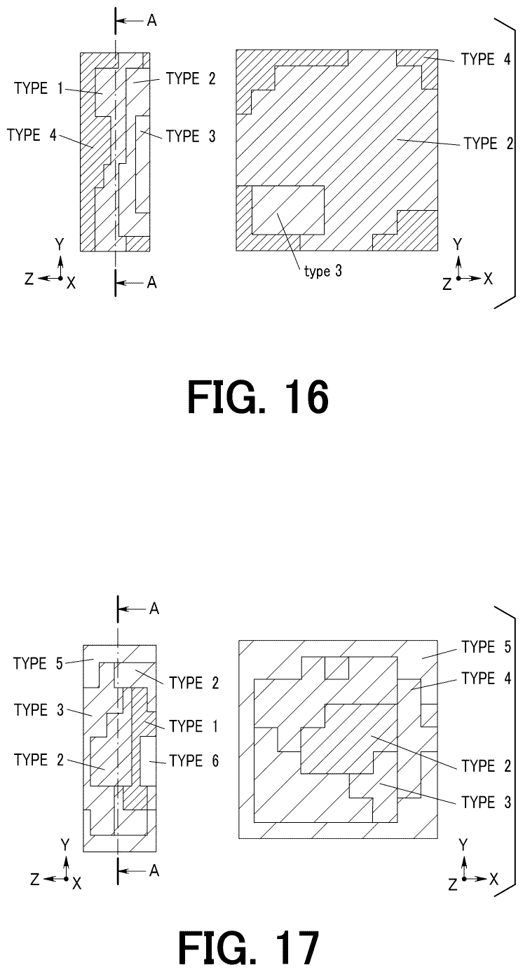

FIG. 16 illustrates a result of classifying the image in FIG. 15 into four types by the method (the number of features=2) indicated in Table 1 (FIG. 9). FIG. 17 illustrates a result of classifying the image in FIG. 15 into six types by the method (the number of features=10) of the present modification.

By using a large number of feature amounts, more detailed type classification can be performed in consideration of blurring of an image and a background. Therefore, according to the present modification, it is possible to obtain a result corresponding to the way of disturbance of the point image that varies depending on the spatial position of the image.

Note that, instead of determining the type of the image, a value corresponding to the distance to the barycentric coordinates of each type may be set as the weight of each type, and a result obtained by applying the model of each type to the image may be multiplied by the weight and combined. For example, the weight is obtained by normalizing for each image based on the reciprocal of the distance. As indicated in Table 5, assuming that distances between the coordinates of an i-th area and the barycentric coordinates of four types are Di1, Di2, Di3, and Di4, the weight of Type 1 is calculated by the formula described below.

{1/(Di1+ε)}/Σk{1/(Dik+ε)}
(ε is a minute number for avoiding division by 0)

Note that, if not all types but about the top three types with small distances are used, the calculation time can be shortened.

The image type classification method of the present modification can also be used in the embodiments and the modifications described above.

The present invention is not limited to the above-described embodiments and the like, and various changes, combinations, modifications, and the like can be made without changing the gist of the present invention.

What is claimed is:

1. An image conversion device comprising a processor, wherein
the processor converts a third three-dimensional fluorescence image of a measurement specimen by first excitation light into a fourth three-dimensional fluorescence image
by using a trained model in which a plurality of pair images, each including a first three-dimensional fluorescence image of a learning specimen by the first excitation light and a second three-dimensional fluorescence image of the learning specimen by second excitation light having a longer wavelength than the first excitation light, is learned as a supervision image.

2. The image conversion device according to claim 1, wherein the first three-dimensional fluorescence image, the second three-dimensional fluorescence image, and the third three-dimensional fluorescence image are scanning microscope images.

3. The image conversion device according to claim 1, wherein the first three-dimensional fluorescence image and the third three-dimensional fluorescence image are images photographed by a one-photon excitation method, and
the second three-dimensional fluorescence image is an image photographed by a two-photon excitation method.

4. The image conversion device according to claim 1, wherein an intensity of excitation light is higher when a deep portion of the specimen is photographed than when a surface of the specimen is photographed.

5. The image conversion device according to claim 1, wherein
the processor further
divides the third three-dimensional fluorescence image into a plurality of fifth three-dimensional fluorescence images,
inputs each of the plurality of fifth three-dimensional fluorescence images to the trained model to convert the plurality of fifth three-dimensional fluorescence images into a plurality of sixth three-dimensional fluorescence images, and
combines the plurality of sixth three-dimensional fluorescence images to generate the fourth three-dimensional fluorescence image.

6. The image conversion device according to claim 5, wherein the processor further
divides the third three-dimensional fluorescence image into the plurality of fifth three-dimensional fluorescence images so as to overlap with an adjacent region.

7. The image conversion device according to claim 6, wherein the processor further
weights a plurality of pixels of the plurality of sixth three-dimensional fluorescence images according to a position of each pixel in the sixth three-dimensional fluorescence image and combines the plurality of sixth three-dimensional fluorescence images.

8. The image conversion device according to claim 7, wherein a weighting factor in weighting the pixels of the sixth three-dimensional fluorescence image is smaller from a pixel at a center position toward a pixel at a peripheral position.

9. The image conversion device according to claim 1, wherein the processor further
calculates a feature amount of the third three-dimensional fluorescence image, and uses the trained model according to the feature amount from among a plurality of types of trained models classified based on the feature amount.

10. The image conversion device according to claim 1, wherein the processor further
scales a luminance of the third three-dimensional fluorescence image in a range of 0 to 1.

11. The image conversion device according to claim 9, wherein the feature amount is at least one of a maximum value of luminance of a plurality of pixels of an image, a standard deviation of luminance of the plurality of pixels, a median of luminance of the plurality of pixels, entropy of the image, a minimum value of luminance of the plurality of pixels, an average value of luminance of the plurality of pixels, a ratio of luminance exceeding a predetermined value to all pixels, a ratio of luminance less than a predetermined value to all pixels, an S/N ratio estimated from autocorrelation of an image, and a local entropy obtained by averaging local entropy in an area.

12. The image conversion device according to claim 1, wherein the processor further
divides the third three-dimensional fluorescence image into a plurality of fifth three-dimensional fluorescence images,
calculates a feature amount of each of the plurality of fifth three-dimensional fluorescence images,
converts each of the plurality of fifth three-dimensional fluorescence images into a sixth three-dimensional fluorescence image using a trained model according to each of the feature amounts from among a plurality of types of trained models classified based on the feature amount, and
combines a plurality of sixth three-dimensional fluorescence images to generate the fourth three-dimensional fluorescence image.

13. The image conversion device according to claim 12, wherein the feature amount is at least one of a maximum value of luminance of a plurality of pixels of an image, a standard deviation of luminance of the plurality of pixels, a median of luminance of the plurality of pixels, entropy of the image, a minimum value of luminance of the plurality of pixels, an average value of luminance of the plurality of pixels, a ratio of luminance exceeding a predetermined value to all pixels, a ratio of luminance less than a predetermined value to all pixels, an S/N ratio estimated from autocorrelation of an image, and a local entropy obtained by averaging local entropy in an area.

14. The image conversion device according to claim 13, wherein the processor further
divides the third three-dimensional fluorescence image into the plurality of fifth three-dimensional fluorescence images so as to overlap with an adjacent region.

15. The image conversion device according to claim 14, wherein the processor further
weights a plurality of pixels of the plurality of sixth three-dimensional fluorescence images according to a position of each pixel in the sixth three-dimensional fluorescence image and combines the plurality of sixth three-dimensional fluorescence images.

16. The image conversion device according to claim 15, wherein a weighting factor in weighting the pixels of the sixth three-dimensional fluorescence image is smaller from a pixel at a center position toward a pixel at a peripheral position.

17. An image conversion method comprising: converting a third three-dimensional fluorescence image of a measurement specimen by first excitation light into a fourth three-dimensional fluorescence image by using a trained model in which a plurality of pair images, each including a first three-dimensional fluorescence image of a learning specimen by the first excitation light and a second three-dimensional fluorescence image of the learning specimen by second excitation light having a longer wavelength than the first excitation light, is learned as a supervision image.

18. The image conversion device according to claim 1, wherein the processor further
divides the third three-dimensional fluorescence image into a plurality of fifth three-dimensional fluorescence images,
calculates a feature amount of each of the plurality of fifth three-dimensional fluorescence images,
converts the plurality of fifth three-dimensional fluorescence images into a plurality of seventh three-dimensional fluorescence images using a plurality of types of trained models classified based on the feature amounts,
combines the plurality of seventh three-dimensional fluorescence images by weighting the plurality of seventh three-dimensional fluorescence images based on the feature amount of each of the plurality of fifth three-dimensional fluorescence images to generate a plurality of sixth three-dimensional fluorescence images, and
combines the plurality of sixth three-dimensional fluorescence images to generate the fourth three-dimensional fluorescence image.

19. An image conversion system comprising:
the image conversion device according to claim 1; and a microscope, wherein at least the third three-dimensional fluorescence image is an image acquired by the microscope.
